(19) United States
(12) Patent Application Publication
(10) Pub. No.: US 2025/0236259 A1
(43) Pub. Date: Jul. 24, 2025

(54) MULTI-LEVEL ACCESS CONTROL SYSTEM FOR A VEHICLE

(71) Applicant: Textron Inc., Providence, RI (US)

(72) Inventors: Gregory August Theodosakis, Martinez, GA (US); Russell William King, Evans, GA (US); Jonathan Daniel Bowen, North Augusta, SC (US)

(73) Assignee: Textron Inc., Providence, RI (US)

(21) Appl. No.: 18/419,499

(22) Filed: Jan. 22, 2024

(51) Int. Cl. B60R 25/24; B60R 25/23; B60R 25/25

(52) U.S. Cl. CPC B60R 25/243; B60R 25/23; B60R 25/25; B60R 2325/30

(57) ABSTRACT

A golf cart includes a user interface and processing circuitry. The processing circuitry is configured to operate the golf cart according to either a first state or a second state where one or more operational capabilities of the golf cart is limited relative to the first state. The processing circuitry is also configured to, responsive to a first request provided by a user via the user interface, transition the golf cart into a third state where the operation of the golf cart is disabled. The processing circuitry is also configured to, responsive to a second request provided by the user via the user interface and a verification of a credential of the user, transition the golf cart out of the third state and into a previously active state that is either the first state or the second state.

### BACKGROUND

The present application relates to a control system for a vehicle. More specifically, the present application relates to an access control system for a vehicle.

### SUMMARY

One embodiment relates to a golf cart. The golf cart includes a user interface and processing circuitry. The processing circuitry is configured to operate the golf cart according to either (1) a first state where one or more operational capabilities of the golf cart is unrestricted or limited at a first level or (2) a second state where the one or more operational capabilities of the golf cart is limited at a second level, the second level of limitation being more restrictive that the first level. The processing circuitry is also configured to, responsive to a first request provided by a user via the user interface, transition the golf cart into a third state where the operation of the golf cart is disabled. The processing circuitry is also configured to, responsive to a second request provided by the user via the user interface and a verification of a credential of the user, transition the golf cart out of the third state and into a previously active state that is either the first state or the second state.

In some embodiments, in the second state, a speed of the golf cart is limited to a threshold. The threshold is less than a speed that the golf cart can achieve in the first state. In some embodiments, in the second state, the golf cart is limited from being driven into a restricted geographic area or out of an approved geographic area.

In some embodiments, the processing circuitry is configured to operate the golf cart according to either the first state or the second state by causing a primary mover of the golf cart to drive a tractive element of the golf cart based on a control input provided by the user. In some embodiments, the one or more operational capabilities of the golf cart is limited according to a user defined threshold. The processing circuitry is configured to receive a third request at the user interface or a personal computer device to set or update the user defined threshold, and, responsive to authorization of credentials provided by the user that indicate sufficient authorization, operate the user interface or the personal computer device to prompt the user to set or adjust the user defined threshold.

In some embodiments, the user interface includes a touch screen and the credential of the user includes a typed credential entered at the user interface including a password or a personal identification number. In some embodiments, the user interface includes a biometric sensor and the credential of the user includes at least one of a fingerprint, an eye scan, facial scan, or voice input of the user.

In some embodiments, the processing circuitry is configured to identify different levels of authorization corresponding to different credentials. The processing circuitry is configured to limit transition of the golf cart out of the second state and into the first state until the user provides credentials corresponding to a first authorization level sufficient to transition the golf cart into the first state in which the golf cart is operable in an unrestricted manner. The processing circuitry is further configured to restrict transition of the golf cart out of the third state into the first state but allow transition of the golf cart into the second state in response both (i) the previously active state being the second state and (ii) obtaining credentials corresponding to a second authorization level insufficient to transition the golf cart into the first state but sufficient to transition the golf cart into the second state.

Another embodiment of the present disclosure is an access control system for a vehicle. The access control system includes processing circuitry. The processing circuitry is configured to operate the vehicle according to either (1) a first state where one or more operational capabilities of the golf cart is unrestricted or limited at a first level or (2) a second state where the one or more operational capabilities of the golf cart is limited at a second level, the second level of limitation being more restrictive that the first level. The processing circuitry is configured to, responsive to a first request provided by a user, transition the vehicle into a third state where the operation of the vehicle is disabled. The processing circuitry is configured to, responsive to a second request provided by the user and a verification of a credential of the user, transition the vehicle out of the third state and into a previously active state that is either the first state or the second state.

In some embodiments, in the second state, a speed of the vehicle is limited to a threshold. The threshold is less than a speed that the vehicle can achieve in the first state. In some embodiments, in the second state, the vehicle is limited from being driven into a restricted geographic area or out of an approved geographic area.

In some embodiments, the processing circuitry is configured to operate the vehicle according to either the first state or the second state by causing a primary mover of the vehicle to drive a tractive element of the vehicle based on a control input provided by the user. In some embodiments, the one or more operational capabilities of the vehicle are limited according to a user defined threshold. The processing circuitry is configured to receive a third request to set or update the user defined threshold, and, responsive to authorization of credentials provided by the user that indicate sufficient authorization, operate a user interface or a personal computer device to prompt the user to set or adjust the user defined threshold.

In some embodiments, the access control system includes a user interface. The user interface includes a touch screen and the credential of the user includes a typed credential entered at the user interface including a password or a personal identification number. In some embodiments, the user interface includes a biometric sensor and the credential of the user includes at least one of a fingerprint, an eye scan, or a voice input of the user.

In some embodiments, the processing circuitry is configured to identify different levels of authorization corresponding to different credentials. The processing circuitry is configured to limit transition of the vehicle out of the second state and into the first state until the user provides credentials corresponding to a first authorization level sufficient to transition the vehicle into the first state in which the vehicle is operable in the unrestricted manner. The processing circuitry is further configured to restrict transition the vehicle out of the third state and into the first state but allow transition of the vehicle into the second state in response both (i) the previously active state being the second state and (ii) obtaining credentials corresponding to a second authorization level insufficient to transition the vehicle into the first state but sufficient to transition the vehicle into the second state.

Yet another embodiment relates to a method of providing access to a vehicle. The method includes operating the vehicle according to either (1) a first state where one or more operational capabilities of the vehicle is unrestricted or limited at a first level or (2) a second state where the one or more operational capabilities of the vehicle is limited at a second level, the second level of limitation being more restrictive that the first level. The method also includes, responsive to a first request provided by a user via a user interface, transitioning the vehicle into a third state where the operation of the vehicle is disabled. The method also includes, responsive to a second request provided by the user via the user interface and a verification of credentials of the user, transitioning the vehicle out of the third state and into a previously active state that is either the first state or the second state.

In some embodiments, in the second state, a speed of the vehicle is limited to a threshold. The threshold is less than a speed that the vehicle can achieve in the first state.

In some embodiments, in the second state, the vehicle is limited from being driven into a restricted geographic area or out of an approved geographic area. In some embodiments, operating the vehicle according to either the first state or the second state includes causing a primary mover of the vehicle to drive a tractive element of the vehicle based on a control input provided by the user.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a block diagram of a multi-level access control system, according to an exemplary embodiment.

FIG. 5 is a flow diagram of a process implemented by the multi-level access control system of FIG. 4, according to an exemplary embodiment.

FIG. 6 is a flow diagram of multiple user interfaces that are presented to a user of the vehicle when the process is implemented by the multi-level access control system of FIG. 4, according to an exemplary embodiment.

FIG. 7 is a block diagram of the multi-level access control system of FIG. 4, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes a multi-level access control system. The multi-level access control system may receive credentials from a user and can transition between an unrestricted state in which all functions of the vehicle can be used, a disabled state in which the only function of the vehicle that can be performed is unlocking or starting, and a performance-altered state in which one or more operational capabilities or performance characteristics of the vehicle are limited. The performance characteristics that are limited may include a maximum allowable speed, a maximum allowable acceleration, restricted geographic range or areas of the vehicle, etc. When the vehicle is transitioned out of the disabled state, the multi-level access control system may be configured to automatically re-activate a previously active state (e.g., either the unrestricted state or a performance-altered state). Advantageously, the multi-level access control system does not require the user to carry separate physical keys and can use various forms of credentials other than unique physical devices or keys to allow the user to transition the vehicle between the different states or adjust settings of the performance-altered state.

The multi-level access control system advantageously provides additional access control to vehicles without the hassle of managing unique keys for each vehicle and with more flexibility than a traditional key. For example, the vehicle may include a common key (e.g., for a commonly keyed car) and the multi-level access control system can impose access control to different states or modes of operation of the vehicle without requiring the user to purchase a unique key for transitioning into specific states or modes of operation, or a unique key that only has access to specific states or modes of operation but not others. Implementing the multi-level access control system with electronics allows more robust and flexible access control. The vehicle can be disabled entirely or have its performance modified. These multiple types of access control can be nested or completely independent. This access control device can reside on the vehicle and does not necessarily require any additional hardware or device such as an external diagnostic handset or physical key. While the vehicle may still be operable with a key and a key switch that is common or unique, the access control devices removes the requirement for additional physical keys in order to limit access to different states or modes of operation of the vehicle.

The multi-level access control system includes an electronic component that provides multi-level access control. The electronic component may reside permanently on the vehicle and can reduce a requirement for the operator carry additional equipment with them or having to spend the time and money to install dedicated access control devices on the vehicle. The multi-level access control system leverages a communications bus or system such as a Controller Area Network (“CAN”) bus will use some form of communication, preferably CAN bus, to send information to a powertrain controller (e.g., an electric vehicle (“EV”) traction motor controller), which causes the multi-level access control system to restrict vehicle operation as commanded by the user or controls.

The multi-level access control system may include a multi-function touch screen gauge or display that communicates with a motor controller on a vehicle CAN bus data network. The multi-function touch screen provides a locking or access control menu and functionality. The multi-level access control system provides two or more levels of access control, which are each protected by a credential (e.g., a PIN, a passcode, a biometric, etc.) and retained by the vehicle operator using the gauge. The two or more levels may include a performance-altered state where an operating characteristic (e.g., a maximum speed, a maximum acceleration, etc.) of the vehicle is limited, and a disabled state where the vehicle is fully disabled and/or locked. The performance-altered state and the disabled state may be effectively nested by nature of the multi-function touch screen gauge remembering a previously enabled state while in the disabled state, and returning to the previously enabled state (e.g., the unrestricted state or the performance-altered state) when unlocked from the disabled state.

The multi-level access control system is advantageous over systems that require common physical keys or unique physical keys because it utilizes a device that is already located on the vehicle for other reasons and allows multiple levels or types of access control, including but not limited to full disable, lowering top speed, altering acceleration or deceleration parameters, or even locking out areas of the multi-function gauge where vehicle parameters can be changed.

### Overall Vehicle

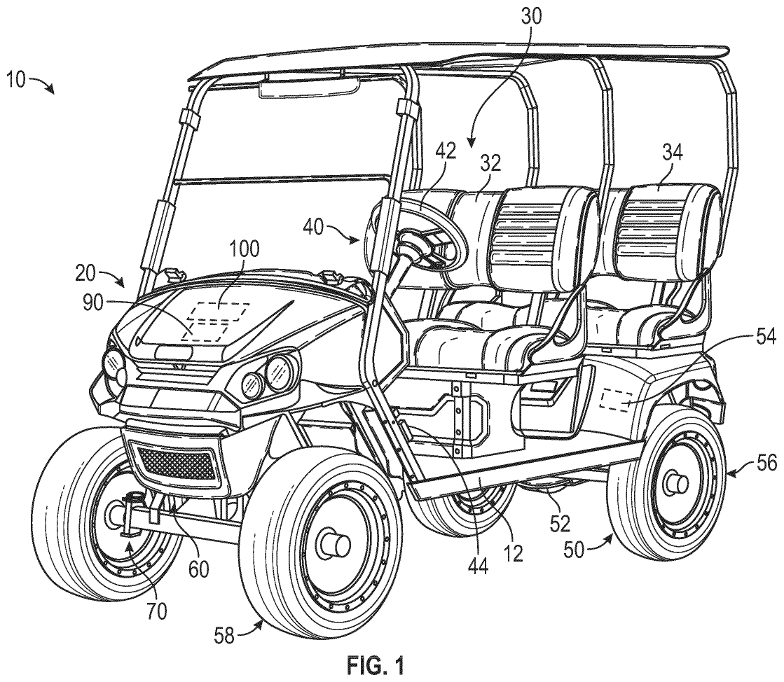

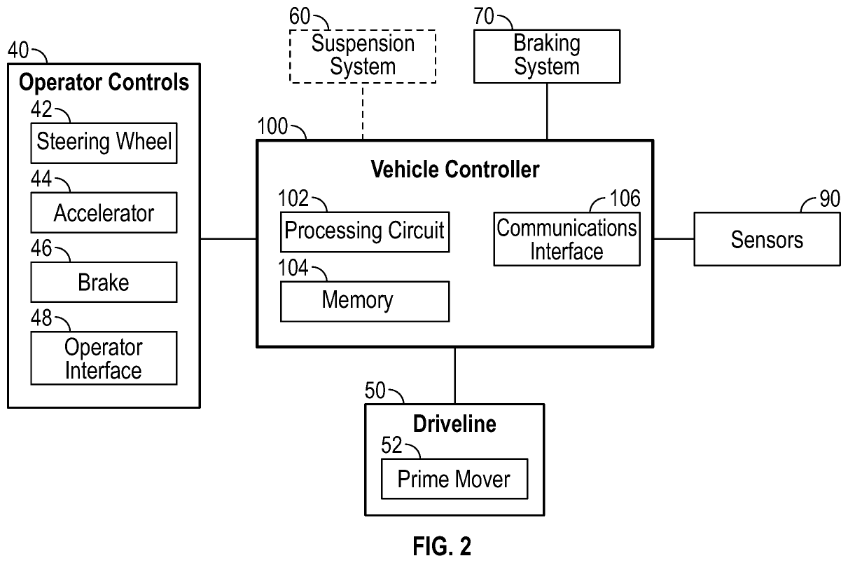

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart, an all-terrain vehicle (“ATV”), a utility task vehicle (“UTV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

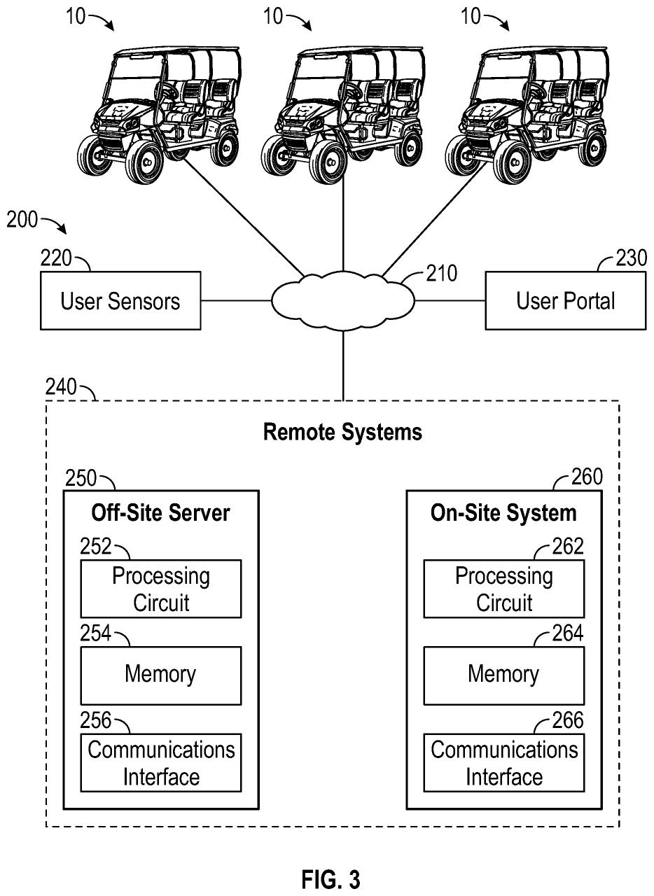

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). The user portal 230 may be or may be accessed via a computer, laptop, smartphone, tablet, or the like.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Multi-Level Access Control System

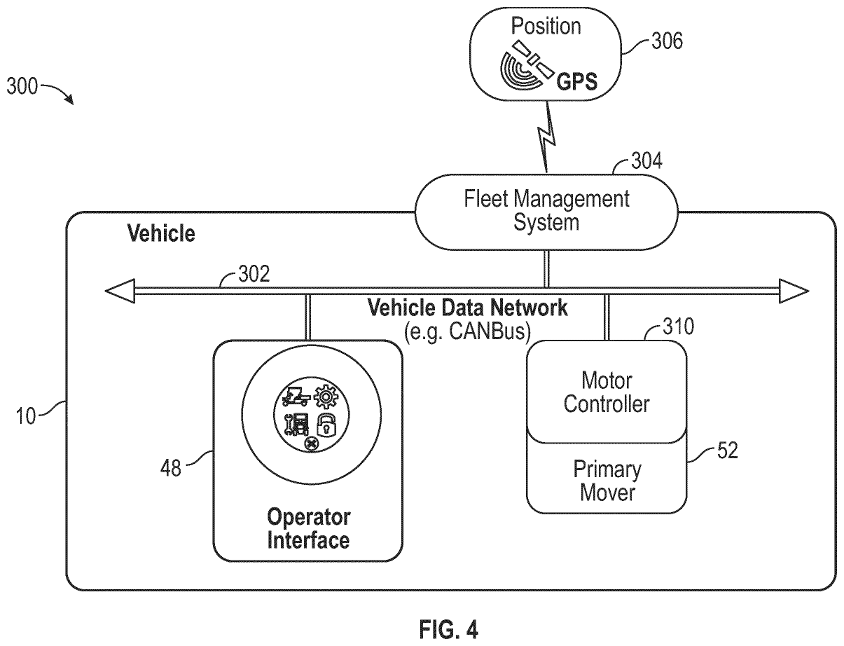

Referring to FIGS. 4-7, the vehicle 10 is equipped with a multi-level access control system 300, according to an exemplary embodiment. The multi-level access control system 300 advantageously facilitates providing different levels of access corresponding to different control modes or allowed performance characteristics or operational capabilities of the vehicle 10, without requiring the user to have a separate physical key or physical object. Many golf carts, snowmobiles, terrain vehicles, or other personal vehicles use common keys which can, without further modifications, be used to operate different vehicles provided by the same manufacturer or of the same model. Providing unique physical keys may present challenges with retaining possession of the unique key, managing keys, and key switches on assembly lines and in field application at point of operation. Further, unique keys only allow the user to completely disable the vehicle, and do not allow the user to restrict certain performance characteristics or operational capabilities while allowing others (e.g., a speed limited operation mode or level of access). Further, requiring the user to carry a specific physical or electronic key corresponding to different access or permission levels of the vehicle requires the user to carry a physical device, which can also result in loss of access to the vehicle if the user loses their physical or electronic key. Advantageously, the multi-level access control system 300 does not require the user to carry a unique physical device in order to access the vehicle 10 or to place the vehicle 10 in a performance-altered state (e.g., a reduced performance state) or a disabled/locked state.

Referring particularly to FIG. 4, the multi-level access control system 300 of the electric vehicle 10 includes a communications bus 302 (e.g., CAN bus), the operator interface 48 (e.g., an interactive touch screen, a display screen and corresponding button set, etc.), a motor controller 310, the prime mover 52 (e.g., an electric motor, a traction motor, etc.), a fleet management system 304 (e.g., the off-site server 250), and a GPS 306 (e.g., the off-site server 250 and/or the sensors 90), according to an exemplary embodiment. The motor controller 310 may be a local or lower level controller that is configured to receive communications on the communications bus 302 (e.g., from the accelerator 44, the brake 46, from the operator interface 48 or a corresponding controller or module of the operator interface 48, etc.) and operate the prime mover 52 according to the communications. In some embodiments, the motor controller 310 is configured to receive communications from the fleet management system 304 and operate or adjust operation of the prime mover 52 based on the communications from the fleet management system 304. The prime mover 52 may be implemented to drive tractive elements of the vehicle 10 through a driveline, or may be implemented as multiple electric motors each corresponding to different tractive elements of the vehicle 10. It should be understood that any configuration of the driveline are intended to be within the scope as described herein, and that the motor controller 310 and the prime mover 52 may represent a single pair of motor controllers and prime movers, or may represent multiple motor controllers and electric motors that are communicably coupled on the communications bus 302.

The multi-level access control system 300 is configured to implement access control to transition the vehicle 10 between an unrestricted state (e.g., a baseline state, a state where speed of the vehicle 10 is not restricted by a speed gauge, etc.), a disabled state, and one or more performance-altered states (e.g., one or more reduced performance states). In the unrestricted state, all the functions, features, and performance of the vehicle 10 are operable, accessible, and unrestricted for the user. For example, the user may be allowed to operate the vehicle 10 to drive, travel at maximum velocities, drive the vehicle away from a location, etc., without restrictions implemented by the multi-level access control system 300. In the unrestricted state, one or more features, functions, or performances of the vehicle 10 may be restricted to a limited degree that is less than a restriction of the features, functions, or performances (e.g., operational characteristics) in the performance-altered state. In the disabled state, the vehicle 10 is restricted from performing a driving or transportation operation by limiting operation of the prime mover 52 (e.g., as controlled by the motor controller 310) so that the vehicle 10 is restricted or prevented from being driven by an unauthorized user. By way of example, the vehicle 10 may be completely disabled in the disabled state with the only available function of the vehicle 10 being unlocking the vehicle 10 (e.g., by entering credentials, to permit starting the vehicle 10 to be driven, etc.). In the performance-altered state(s), one or more artificial constraints are placed on the vehicle 10 so that the vehicle 10 operates with partially restricted, reduced, altered, or adjusted performance characteristics or operational capabilities. For example, the reduced performance characteristics or operational capabilities may be a speed restriction such that the vehicle 10 is limited from exceeding a particular speed. The reduced performance characteristics or operational capabilities may also include disabling or limiting activation of certain features. The reduced performance characteristics or operational capabilities may also include limiting an acceleration rate of the vehicle 10 so that the vehicle 10 cannot be accelerated at a rate greater than a threshold, which is set lower than a maximum ability of the vehicle 10. The reduced performance characteristics or operational capabilities can also include limiting areas which the vehicle 10 can be driven such as only allowing operation of the vehicle 10 within a certain geographic area (e.g., within a geofence), only allowing operation of the vehicle 10 along certain trails or on certain property, etc.

It should be understood that any of the performance characteristics or operational capabilities described herein may be set independently in separate performance-altered states, or may be set in combination with each other (e.g., limited speed and limited range within a specific geographic area in a single performance-altered state). The vehicle 10 may be set to one of the states by a user input. The specific performance characteristic reductions or limitations may also be set by the user via user input at the operator interface 48 by type (e.g., reduced speed, reduced acceleration, reduced range, etc.) and value (e.g., speed limited to a user-defined or user-selected value, acceleration limited to a user-defined or user-selected value, range limited to a user-defined or user-selected value, etc.). In some embodiments, the multi-level access control system 300 stores information regarding a previously used one of the unrestricted state or the performance-altered state and is configured to default back into the previously used unrestricted state or performance-altered state when being transitioned out of the disabled state. The user may provide user inputs including a verifier or credential (e.g., a personal identification number (PIN); a biometric such as a fingerprint scan, facial recognition, an eye scan, a voice command, etc.; a password; a passphrase; etc.) at the operator interface 48 in order to transition the vehicle 10 between the disabled state, the unrestricted state, or the performance-altered state. The user may also provide user inputs including settings for the performance-altered state via the operator interface 48 (e.g., setting the value of the restricted performance characteristics, selecting which of the performance characteristics to limit or restrict, etc.). A controller associated with the operator interface 48 or the fleet management system 304 (e.g., the vehicle controller 100, the processing circuit 252, etc.) may generate controls for the motor controller 310 and the primary mover 52 in accordance with the user inputs provided via the operator interface 48 to implement the unrestricted state, disabled state, or performance-altered state.

For example, some vehicles are provided with valet keys. The multi-level access control system 300 can effectively allow a user with specific credential authorization or access level to set one or more custom valet modes or states where operational characteristics (e.g., speed, location of travel, etc.) of the vehicle 10 are limited. The user may set specific values for restrictions on the operational characteristics of the vehicle 10 and may define various credentials (e.g., PINs) that can be assigned to other personnel which only allow access of the vehicle 10 in the performance-altered state, or in a custom valet state. Advantageously, the multi-level access control system 300 allows the user to customize the performance-altered state and the corresponding credentials authorized to access the vehicle 10 in the performance-altered state, or to define new custom states (e.g., valet states). The multi-level access control system 300 allows the addition of unique customizable restrictions in a mode or state-based operational manner of the vehicle 10 with approved or authorized users by their credentials. The multi-level access control system 300 may allow the definition of custom states or modes in addition to factory-set states or modes (e.g., the performance-altered state).

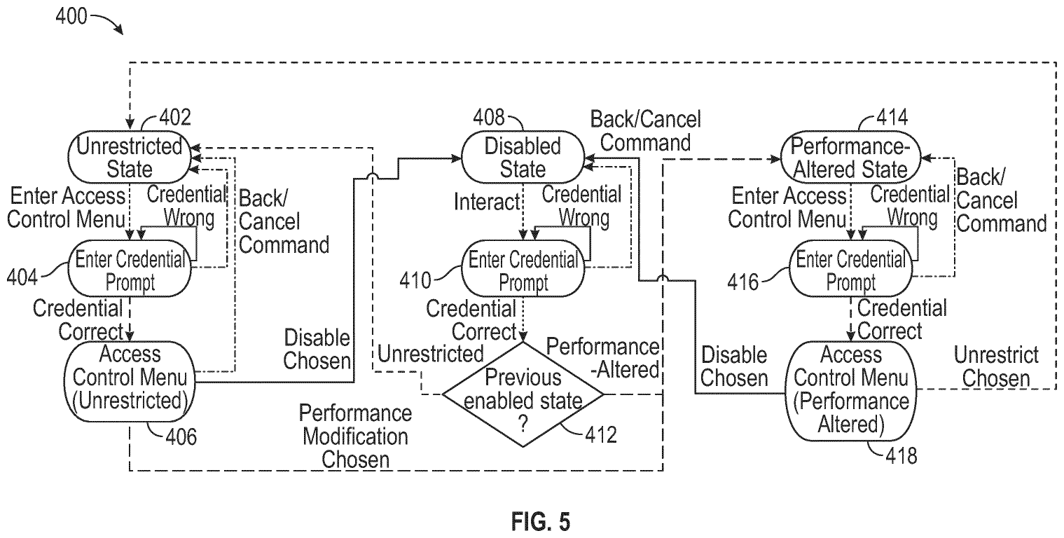

Referring to FIG. 5, a flow-state diagram of a process 400 for implementing multi-level control access at the vehicle 10 includes steps 402-418, according to an exemplary embodiment. The process 400 is implemented by the multi-level access control system 300, or processing circuitry thereof. It should be understood that the process 400 may be performed by a single circuit locally at the vehicle 10 (e.g., the vehicle controller 100), multiple circuits or circuitry at the vehicle 10 that operate in a distributed and coordinated manner (e.g., the vehicle controller 100, the motor controller 310, etc.), or a combination of local circuitry at the vehicle 10 and remote circuitry (e.g., a cloud computing system, the fleet management system 304, the off-site server 250, etc.).

The process 400 includes operating the vehicle 10 in the unrestricted state (step 402), according to some embodiments. Operating the vehicle 10 in the unrestricted state includes receiving various control inputs from the user such as steering wheel adjustments, accelerator pedal operation, brake pedal operation, accessory operations, etc., and controlling operation of corresponding motors, actuators, electrical components, primary movers, transmissions, braking or steering systems, etc., of the vehicle 10 responsive to the control inputs in order to implement requested operations (e.g., driving operations, braking operations, steering operations, etc.). When the vehicle 10 operates in the unrestricted state at step 402, the vehicle 10 operates without user-defined constraints or limits on the performance characteristics or operational capabilities of the vehicle 10 (e.g., without a limited speed, without limiting acceleration, without a limited range or geographic area, etc.).

Responsive to receiving a request to enter an access control menu (e.g., by the user interacting with the operator interface 48 such as selecting an icon on a touch screen), the process 400 proceeds to step 404 where the user is prompted to enter a first credential (e.g., a PIN, a password, a biometric, etc.) by presenting a credential verification interface on a screen of the operator interface 48. If the first credential is incorrect, the process 400 stays at step 404 and notifies the user that the first credential could not be verified. The user may either go back to the step 402 (e.g., to a main menu and continue operating in the unrestricted state) or may re-enter the first credential correctly. Once the user enters the first credential correctly (e.g., the correct PIN, the correct password, a verifiable biometric such as a finger print, eye scan, facial recognition, voice recognition, gesture command, etc.), the user is presented with an unrestricted access control menu at step 406. In the unrestricted access control menu, the user may provide different inputs or interactions with the operator interface 48 to (a) go back or cancel the command thereby returning the operating in the unrestricted state at step 402, (b) disabling the vehicle 10 to thereby transition the vehicle 10 into the disabled state at step 408, or (c) modifying a performance characteristic and transitioning the vehicle 10 into the performance-altered state at step 414. The performance characteristic can be modified by selecting different performance characteristics or parameters and setting values for the performance characteristics or parameters (e.g., speed limitation, acceleration limitation, range limitation, runtime limitation, approved users for the vehicle 10, approved credentials or PINS to use the vehicle 10 in the performance-altered state, etc.). The user at step 406 may also set different performance-altered states (e.g., multiple performance-altered states) and can select which of the performance-altered states to default to when re-starting or re-enabling the vehicle 10.

If the user selects to disable the vehicle 10, from the unrestricted state and the unrestricted access control menu 406, process 400 proceeds to step 408 and the vehicle 10 is transitioned into the disabled state. In the disabled state, the vehicle 10 is restricted from performing driving operations (e.g., the motor controller 310 restricts operation or any activation of the primary mover 52 to transport the vehicle 10). When the vehicle 10 is in the disabled state at step 408, the user may interact with the operator interface 48 (e.g., by selecting an icon on the touch screen or pressing a button on a button set) and proceed to a credential verification interface at step 410 (similar to step 404). At step 410, the credential verification interface prompts the user to enter a second credential (e.g., a PIN). The second credential may be the same as or different than the first credential. If the second credential is incorrect, the process 400 remains at step 410 until the user either cancels the credential verification interface (e.g., the user selects “go back” and returns to a normal menu at step 408 and the vehicle 10 remains in the disabled state), or enters the second credential correctly. If the user enters the second credential correctly (e.g., enters the correct PIN, enters a verifiable password, provides a verifiable or approved biometric indicating an approved user or owner of the vehicle 10), the process 400 proceeds to step 412.

At step 412, the process 400 includes identifying a previously active state of the vehicle 10. For example, if the previously active state of the vehicle 10 was the unrestricted state at step 402 (the previous active state before being transitioned into the disabled state at step 408), the process 400 proceeds from the step 412 to the step 402 and the vehicle 10 is transitioned into the unrestricted state. However, if the previously active state was the performance-altered state at step 414, the process 400 proceeds from step 412 to step 414 and the vehicle 10 is transitioned into the performance-altered state. It should be understood that the multi-level access control system 300 is configured to implement multiple performance-altered states, according to various exemplary embodiments, and if multiple performance-altered states have been defined, the process 400 at step 412 returns to the previously active performance-altered state of the multiple performance-altered states. By way of example, if the multi-level access control system 300 of the vehicle 10 includes a first performance-altered state in which the range of the vehicle 10 is limited (e.g., to be within a geofence) and a second performance-altered state in which the speed of the vehicle 10 is limited (e.g., speed of the vehicle 10 is limited to 10 miles per hour), and the previously active state of the vehicle 10 was the first performance-altered state, the process 400 at step 412 returns to the first performance-altered state instead of the second performance-altered state, according to one embodiment. In another embodiment, one of the multiple performance-altered states are set by the user (e.g., by a user with a sufficient level of access control of the vehicle 10 such as an owner, administrator, or manufacturer of the vehicle 10) as being a default and the multi-level access control system 300 always returns to the default performance-altered state upon being requested to transition out of the disabled state. In some embodiments, the second credential may include two different credentials: a first one (e.g., an owner credential, an administrator credential, etc.) that will default the vehicle 10 back to the unrestricted state even if the previous state was the performance-altered state and a second one (e.g., a guest user credential, a child credential, etc.) that will default the vehicle 10 back to the performance-altered state.

When the vehicle 10 is operating in the performance-altered state at step 414, one or more of the performance characteristics or operational capabilities of the vehicle 10 are limited or altered such that operation of the vehicle 10 is altered. The user may interact with the operator interface 48 (e.g., the touch screen) such as by selecting an icon to transition to an access control menu at which point the user is presented with a credential verification interface by a screen of the operator interface 48 at step 416. The credential verification interface prompts the user to enter a third credential (e.g., PIN, password, passphrase, biometric, etc.). The third credential may be the same as or different than the first credential and/or the second credential. If the user enters the third credential and it cannot be verified, the process 400 remains at step 416. The user may also select to go back, leave the credential verification interface, or cancel the access to the access control menu in which case the process 400 returns to step 414 (e.g., returns to the main menu and continues operating the vehicle in the performance-altered state). If the user enters the third credential and the third credential is verified at step 416, the process 400 proceeds to step 418 and provides a performance altered access control menu to the user via the screen of the operator interface 48. The performance altered access control menu provides the user with selectable options to either transition into the disabled state at step 408 or to transition into the unrestricted state at step 402. The process 400 proceeds to step 408 or step 402 depending on the selection provided by the user at the performance altered access control menu.

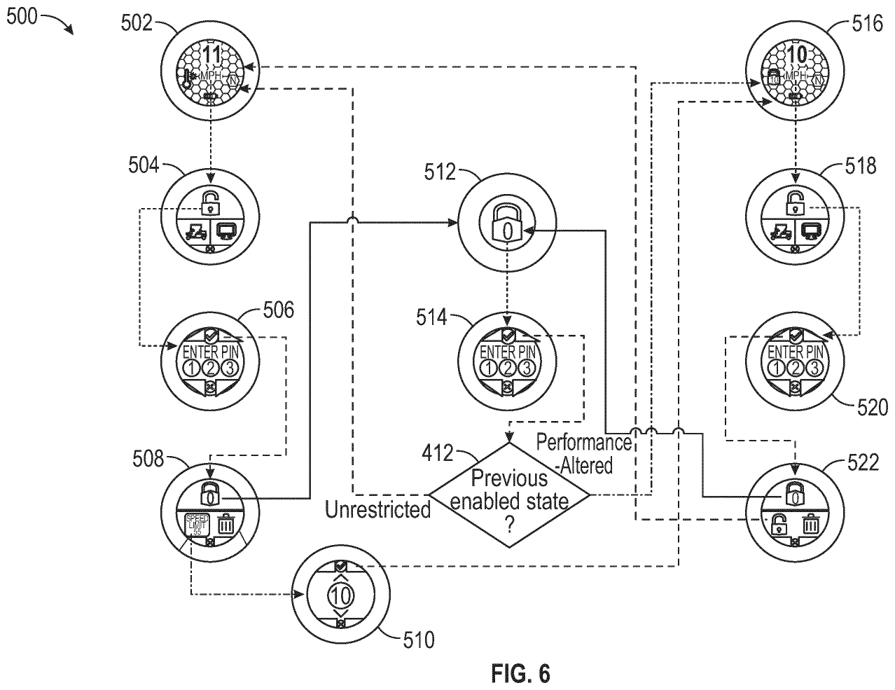

Referring to FIG. 6, a graphical user interface (“UI”) flow diagram illustrates various UIs 500 that are presented to the user on the screen of the operator interface 48. A first UI 502 (e.g., a graphical UI or “GUI”) is presented to the user when the vehicle 10 is operating according to the unrestricted state at step 402. The first UI 502 includes icons, textual information, values, etc., indicating one or more current operating parameters of the vehicle 10 including current speed, a current gear, a battery level, a temperature, etc. The first UI 502 may be an information display screen that presents various operational data of the vehicle 10 for viewing by the user while performing driving operations of the vehicle 10. A second UI 504 is presented to the user when the user selects an icon to view a main menu. If the user selects an icon on second UI 504 corresponding to the unrestricted access control menu (e.g., a lock icon), the screen of the operator interface 48 is controlled to display a third UI 506 (e.g., the credential verification interface). The third UI 506 may include a prompt for the user to enter the first credential and may also include icons (e.g., button icons, numbers, a keyboard, a keypad, etc.) to allow the user to enter the first credential via the screen of the operator interface 48. If the vehicle 10 is not equipped with a touchscreen or the credentials are not typable (e.g., the credentials are biometric), the third UI 506 can present a textual message prompting the user to enter the first credential at a separate device (e.g., on a separate keypad, to look into a camera, to press their finger on a specific scanner, to speak, etc.).

Responsive to entering proper credentials and the credential being verified (e.g., entering a correct PIN), a fourth UI 508 is presented to the user via the screen of the operator interface 48. The fourth UI 508 may include various selectable performance characteristics or operational capabilities of the vehicle 10 and corresponding fields or adjustments for the performance characteristics or operational capabilities. In particular, the fourth UI 508 illustrates a non-limiting example of the unrestricted access control menu where the user may set various performance modifications or alterations for the vehicle 10. The fourth UI 508 may include a lock icon that can be selected to transition the vehicle 10 into the disabled state, a speed limit or other performance characteristic icons to navigate to a fifth UI 510 to adjust a performance characteristic alteration value, and a delete icon or button (shown as a trash can) to delete one or more currently active performance characteristic alterations or to exit the current UI and return to the first UI 502.

Responsive to selecting the lock icon, the vehicle 10 may be transitioned into the disabled state (e.g., represented by UI 512). Responsive to selecting the performance characteristic icon, the user may be presented with the fifth UI 510. Responsive to selecting the delete icon or button, a corresponding performance characteristic alteration is deleted and the performance-altered state is updated and/or the user is returned to the first UI 502 or the second UI 504. The fourth UI 508 may also include a back or a cancel button that, when selected by the user, return the vehicle 10 to the unrestricted state and cause the screen of the operator interface 48 to return to the first UI 502 or the second UI 504.

The performance modifications or alterations for the vehicle 10 may further be obtained by presenting the fifth UI 510 that corresponding to a selected one of the performance characteristics or operational capabilities at the fourth UI 508. The example shown in FIG. 6 illustrates a speed limit setting where the user may adjust a maximum allowable speed limit for the vehicle 10 when operating in the performance-altered state. The fifth UI 510 can include adjustment toggles or buttons to adjust the value of the performance characteristic alteration (e.g., to increase or decrease the maximum allowable speed limit for the vehicle 10). Responsive to completing the performance characteristic alteration (e.g., adjusting the value of the performance characteristic alteration and selecting a confirmation icon), an eighth UI 516 is provided on the screen of the operator interface 48.

When the vehicle 10 is transitioned into the disabled state, the screen of the operator interface 48 is operated to provide a disabled UI, shown as sixth UI 512. The sixth UI 512 may include a lock icon indicating that the vehicle 10 is currently in the disabled or locked state. The user may provide an input to the screen of the operator interface 48 at the sixth UI 512 in order to navigate to a seventh UI 514 where the user is prompted to enter the second credential. The sixth UI 514 may be substantially the same as the third UI 506.

After entering the second credential via the seventh UI 514, step 412 is performed and a corresponding UI for the previously active state of the vehicle 10 is presented to the user. For example, if the previously active state of the vehicle 10 was the unrestricted state, the first UI 502 is presented to the user. On the other hand, if the previously active state of the vehicle 10 is the performance-altered state, the eighth UI 516 is presented to the user via the screen of the operator interface 48. If the vehicle 10 is not equipped with a touchscreen or the credentials are not typable (e.g., the credentials are biometric), the seventh UI 514 can present a textual message prompting the user to enter the second credential at a separate device (e.g., on a separate keypad, to look into a camera, to press their finger on a specific scanner, to speak, etc.).

The eighth UI 516 may be similar to the first UI 502 but may include one or more icons indicating that one or more performance characteristics or operational capabilities of the vehicle 10 are altered, limited, reduced, or restricted. For example, if the performance-altered state is a speed limited state, the eight UI 516 can include a lock indicating that the speed of the vehicle 10 is limited to a particular value (e.g., 10 miles per hour).

Responsive to receiving a selection at the eighth UI 516 indicating that the user desires to transition out of the performance-altered state that is currently active on the vehicle 10, a ninth UI 518 and subsequently tenth UI 520 are presented to the user on the screen. The ninth UI 518 and the tenth UI 520 are substantially the same as the second UI 504 and the third UI 506, respectively. If the user provides the third credential at the tenth UI 520, an eleventh UI 522 is presented to the user via the screen. The eleventh UI 522 is similar to the fourth UI 508 but includes a selectable icon (e.g., a green unlocked lock icon) that the user can select to transition the vehicle 10 into the unrestricted state and navigate to the first UI 502.

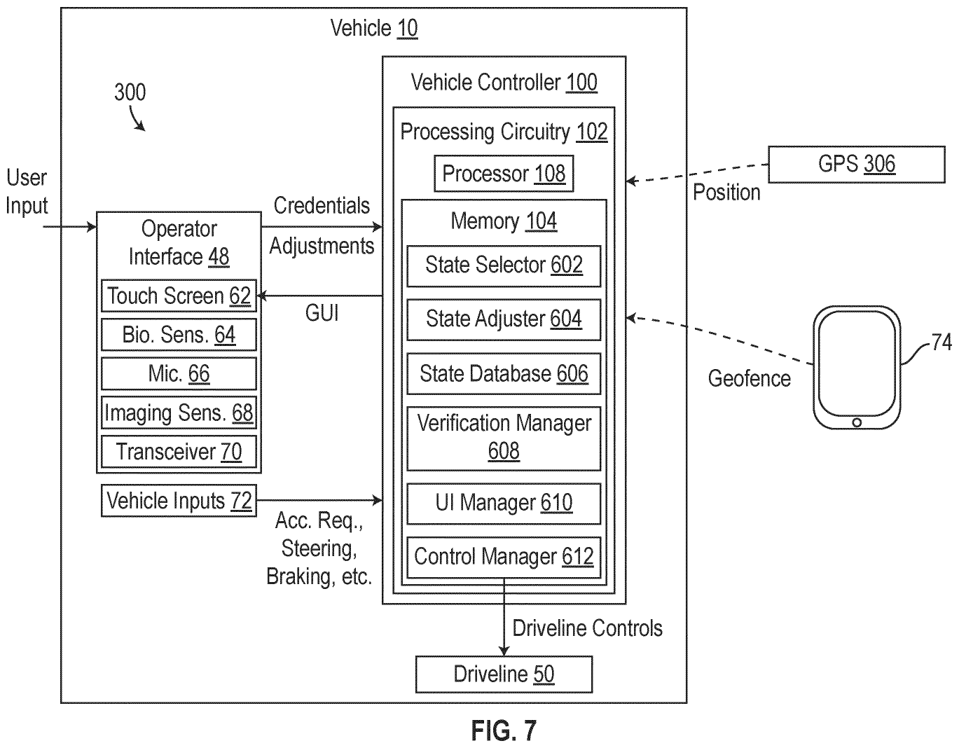

Referring to FIG. 7, a diagram illustrates the multi-level access control system 300. The multi-level access control system 300 includes the operator interface 48, the vehicle controller 100, the GPS 306, the driveline 50, and a personal computing device, shown as user device 74. The operator interface 48 includes a touch screen 62, and may also include one or more of a biometric sensor 64, a microphone 66, an imaging sensor 68, or a wireless transceiver 70. The touch screen 62 of the operator interface 48 is configured to display any of the UIs described herein or described in greater detail above with reference to FIGS. 5 and 6. The touch screen 62 is also configured to obtain user inputs including but not limited to, credentials, UI navigation inputs, state transitions, performance modifications or alterations to one or more performance characteristics or operational capabilities of the vehicle 10, etc. The biometric sensor 64 is configured to obtain biometric credentials and may include a fingerprint scanner, an eye scanner, etc. The microphone 66 is configured to obtain audio data spoken by the user (e.g., an aural credential). The imaging sensor 68 (e.g., a camera) is configured to obtain visual credentials and may obtain image data for processing by the vehicle controller 100 to implement facial recognition as a form of credentials. The transceiver 70 can be any wireless radio, receiver, emitter, or transceiver configured to communicate with a user device (e.g., a smartphone) via Bluetooth, LoRA, Zigbee, near field communications (“NFC”), radio frequency identification (“RFID”) tags, etc., in order to wirelessly obtain credentials from the user device 74. The multi-level access control system 300 may also include or receive data from vehicle inputs 72. The vehicle inputs 72 include any devices through which the user operates the vehicle 10 such as the steering wheel 42, the accelerator 44, the brake 46, etc.

The processing circuitry 102 of the vehicle controller 100 may be implemented in a single controller or multiple distributed controllers throughout the vehicle 10. For example, any of the functions of the vehicle controller 100 as described herein can be performed by the fleet management system 304, the motor controller 310, a microcontroller or processor of the operator interface 48, local controllers or processing units of any components of the driveline 50 of the vehicle 10, etc., or any combination thereof.

The vehicle controller 100 includes the processing circuitry 102, a processor 108, and the memory 104. The memory 104 includes a state selector 602, a state adjuster 604, a state database 606, a verification manager 608, a UI manager 610, and a control manager 612. The vehicle controller 100 as described herein may be configured to operate the operator interface 48 and the driveline 50 in order to implement the process 400 as described in greater detail above with reference to FIG. 5. The UI manager 610 may store any of the UIs 500 as described in greater detail above with reference to FIG. 6 and is configured to operate the touch screen 62 in the manner described in greater detail above with reference to FIG. 6.

The state selector 602 is configured to select one of multiple states from the state database 606. The state database 606 stores various states and corresponding allowed operations and controls of the vehicle 10. In particular, the state database 606 includes the disabled state in which operation of the vehicle 10 is disabled, the unrestricted state in which all functions and features of the vehicle 10 are enabled and can be implemented without restriction on any performance characteristics or operational capabilities (e.g., a normal or maximum speed allowable mode or state), and the performance-altered state. The performance-altered state may include a single performance-altered state or may include multiple performance-altered states. The state selector 602 is configured to, responsive to user inputs provided at the operator interface 48, select one of the states from the state database 606, and notify the UI manager 610 and the control manager 612 regarding the selected state in which the vehicle 10 is to be operated. The state selector 602 may obtain the state from the database and activate the obtained state responsive to an input from the verification manager 608 indicating that credentials provided at the operator interface 48 have been verified.

The state selector 602, when transitioning the vehicle 10 out of the disabled state, may select the state from the state database 606 based on a previously active state or a default state. For example, the state database 606 may include buffers or data fields that indicates a currently active state and a previously active state. The currently active state is updated whenever the state selector 602 obtains a new state from the state database 606. The previously active state indicates a state that the vehicle 10 was previously operating in. If the currently active state is the disabled state and the state selector 602 has received authorization from the verification manager 608 to select a new state responsive to proper credentials being entered by the user, the state selector 602 may reference the previously active state stored in the state database 606 and transition the vehicle 10 into the previously active state. If the currently active state is the unrestricted state, the state selector 602 does not need to reference the previously active state and instead transitions the vehicle 10 into the state requested by the user via the operator interface 48 (e.g., the disabled state or the performance-altered state) assuming the credentials have been verified by the verification manager 608. Likewise, if the currently active state is the performance-altered state, the state selector 602 transitions the vehicle 10 directly into the state requested by the user (e.g., the unrestricted state or the disabled state) assuming the credentials have been verified by the verification manager 608.

The verification manager 608 is configured to obtain credentials from the operator interface 48 (e.g., a PIN, a password, a passphrase, an image of the user's face, fingerprint data, a transmission provided by a user's smartphone or other personal computer device, a key, a string, audio data of the user's voice, etc.) and determines if the credentials can be verified. For example, if the credentials are a PIN, the verification manager 608 may simply determine if the PIN matches with a verified PIN and notify the state selector 602 and the state adjuster 604 if the PIN matches the verified PIN (e.g., the credentials are verified). The verification manager 608 may similarly perform a biometric identification technique such as matching fingerprint data obtained from the biometric sensor 64 to a database of fingerprint data, matching extracted facial features to a database of facial features, matching speaking patterns, phonemes, etc., of the audio data of the user's voice to a database of speaking patterns, matching the key with a database of keys, etc., in order to verify the credentials. Specifically, the verification manager 608 may compare any of the credentials (e.g., the PIN) to a database of calculations based on one or more hashes that are calculated based on the credentials (e.g., the PIN).

In some embodiments, the verification manager 608 is configured to maintain verified credentials to be active for a period of time following entry of verified credentials. For example, the verification manager 608 can include a timer that, when credentials are entered and verified, begins to count down from a specific time (e.g., five seconds, ten seconds, fifteen seconds, etc.) and provides a grace period within which the user may provide user inputs (e.g., adjustments to which state is currently active, adjustments to performance characteristics or operational capabilities when adjusting the performance-altered state, etc.) that are assigned the corresponding level of the credentials. The timer may be reset to the specific time and re-initiate the countdown any time the user operates with the operator interface 48 (e.g., the touch screen 62) after providing verified credentials and before the timer has expired (e.g., reached zero). If the timer expires, the user may be required to re-enter the credentials to resume editing or adjusting the performance characteristics or operational capabilities, or to transition the vehicle 10 between different states in accordance with authorization level of the credentials entered. Advantageously, the timer countdown being re-initiated every time the user touches the touch screen 62 and before expiration of the timer allows the user to make a variety of setting changes (e.g., changing a maximum allowable speed setting from 7 to 10 miles per hour for the performance-altered state and/or escaping a lock setting that the user accidentally applied) quickly and easily without requiring re-entry of the credentials.

The state adjuster 604 is configured to receive adjustments to one or more performance characteristics or operational capabilities for adjusting the performance-altered state. The state adjuster 604 is configured to receive the adjustments to specific performance characteristics or operational capabilities from the operator interface 48 (e.g., entered by the user via the touch screen 62) and write the adjustments or alterations of the performance characteristics or operational capabilities to the state database 606 if the UI manager 610 is currently operating the touch screen 62 to display the access control menu (e.g., the fourth UI 508 and/or the fifth UI 510).

The control manager 612 is configured to receive controls from the vehicle inputs 72 and operate the driveline 50 according to the vehicle inputs 72 and subject to the currently active state of the vehicle 10. For example, if the unrestricted state is currently active, the control manager 612 does not limit operation of the driveline 50. If the disabled state is active, then the control manager 612 limits any activation of the driveline 50 such that the vehicle 10 is disabled. If the performance-altered state is active, the control manager 612 provides driveline controls or adjustments to the driveline 50 such that the driveline 50 operates according to the controls provided by the user at the vehicle inputs 72 and such that the performance characteristics or operational capabilities of the vehicle 10 are limited according to the values set in the performance-altered state (e.g., maintaining the speed of the vehicle 10 below a threshold, only allowing the vehicle 10 to be driven within a particular geographic area or geofence, etc.). In some embodiments, the vehicle controller 100 is configured to operate the driveline 50 directly (e.g., generating control signals for the primary mover 52 and other components of the driveline 50). In some embodiments, the vehicle controller 100 is configured to provide adjustments to local controllers of devices of the driveline 50 (e.g., to the motor controller 310 of the primary mover 52, to a controller of the transmission device of the driveline 50, etc.). The driveline 50 of the vehicle 10 may be an electric driveline, a gasoline or internal combustion engine driveline, a hydrogen cell, etc., or any other form of driveline. The features of the multi-level access control system 300 described herein may be applicable to any sort of driveline for the vehicle 10. The vehicle controller 100 may implement the unrestricted state, the disabled state, or any of the performance-altered states described herein by communicating directly with controllers of driveline components, directly communicating with the driveline components, or by communicating with an intermediary system that communicates with the controllers of the driveline components.

The UI manager 610 is configured to operate the touch screen 62 to provide different UIs to the user responsive to interactions and currently active states of the vehicle 10. The UI manager 610 operates the touch screen 62 to provide the first UI 502 when the vehicle 10 is in the unrestricted state, the UI manager 610 operates the touch screen 62 to provide the sixth UI 512 when the vehicle 10 is in the disabled state, and the UI manager 610 operates the touch screen 62 to provide the eighth UI 516 when the vehicle 10 is in the performance-altered state. In some embodiments, the UI manager 610 is configured to provide the UIs 500 as described in greater detail above with reference to FIG. 6 according to the navigation controls provided by the user at the touch screen 62.

Referring particularly to FIGS. 5 and 7, the multi-level access control system 300 may use multiple credentials having different authorizations in order to transition the vehicle 10 between the unrestricted state, the disabled state, and one or more performance-altered states. In some embodiments, a highest level credential (e.g., a first PIN) enables the user to transition between all of the unrestricted state, the disabled state, and all of the one or more performance-altered states. The highest level credential may also enable the user to adjust settings or performance characteristic thresholds of the performance-altered states. In some embodiments, performance modification can only be performed after entering a credential with sufficient authorization level from the unrestricted state 402 or a corresponding UI (e.g., the first UI 502). For example, to transition from the performance-altered state to the unrestricted access menu (e.g., the fourth UI 508 and the fifth UI 510) to modify the performance characteristics or operational capabilities, the user may be required to enter their credentials twice: first to transition into the unrestricted state and again to transition to the unrestricted access menu where the performance characteristics or operational capabilities can be modified. In some embodiments, a separate credential, when entered, automatically results in the UI manager 610 operating the touch screen 62 to display the unrestricted access menu (e.g., the fourth UI 508 and the fifth UI 510), thereby reducing a number of credential entries required.

One or more credentials may be associated with lower authorization levels. For example, certain credentials may only have authorization to transition the vehicle 10 out of the disabled state and into the previously active state. In this case, if the previously active state is a performance-altered state, the user with the credential associated with lower authorization levels is not allowed to transition the vehicle 10 into the unrestricted state or to modify the settings for the performance-altered states.

Referring particularly to FIG. 7, the vehicle controller 100 may be configured to communicate with the GPS 306 in order to implement a performance-altered state that restricts locations through which the vehicle 10 can be driven. For example, the vehicle controller 100 may obtain a position of the vehicle 10 from the GPS 306 and compare the position of the vehicle 10 to a corresponding geofence of geographic boundaries of a currently active performance-altered state. The vehicle controller 100 can cause operation of the driveline 50 of the vehicle 10 (e.g., directly, by communicating with a controller of the driveline components 50, or by communicating with a separate intermediate system) to prevent the vehicle 10 from being driven outside the geofence or beyond the geographic boundaries. In some embodiments, one or more properties of the geofence or geographic boundaries can be set by the user (after entering sufficiently authorized credentials) at the operator interface 4. For example, the UI manager 610 may operate the touch screen 62 to display a map of a geographic area and allow the user to draw boundaries onto the map to define the geofence or the geographic boundaries for the vehicle 10. In some embodiments, the geofence or geographic boundaries are provided by the user device 74 (e.g., a smartphone, a desktop computer, a laptop, etc.) via the user portal 230 to the vehicle controller 100. The vehicle controller 100 may utilize a cellular dongle or chip, a WiFi transceiver, Bluetooth, etc., to wirelessly communicate with the user device 74. The user device 74 may implement an application that configures the user device 74 to communicate with the vehicle controller 100 or may connect to a website on the Internet (e.g., a Pace web server, the user portal 230, etc.). The application or the website (e.g., of the user portal 230) can provide a UI for the user to define the geofence or geographic boundaries for the vehicle 10 which are then provided to the vehicle controller 100. In some embodiments, the multi-level access control system 300 (e.g., the vehicle controller 100 of the vehicle 10) can be controlled by a user via the user device 74. For example, the user may provide credentials as they would at on-board the vehicle 10 in order to transition the vehicle 10 between the different modes or states as described herein. The multi-level access control system 300 may implement internet connectivity, mesh networking capabilities, etc., in order to allow the user to interact with the vehicle controller 100 that implements the different states or modes at the user device 74.

For example, the owner of the vehicle 10 may desire to ensure that the vehicle 10 is not taken outside of the neighborhood by the owner's family members, or to ensure that the vehicle 10 does not leave the owner's property, does not travel on a trail requiring a high driving skill level, etc. The owner may, by providing proper credentials either at the operator interface 48 or on their user device 74, define the geographic boundaries or geofences for one or more authorized areas so that the vehicle 10 is restricted from traveling outside of the geographic boundaries or geofences. The owner may also provide a setting for allowing an operator of the vehicle 10 to leave the geographic boundaries or geofences provided the operator of the vehicle enters an appropriate credential. The owner or user may set the credential (e.g., set a specific PIN) and tag the credential to a geographic area or geofence such that the vehicle 10 is prevented from traveling outside of the geographic area or geofence or is prevented from entering a specific geographic area or geofence unless the operator of the vehicle 10 enters the credential set by the owner or user. The geographic limitations of the vehicle 10 can be implemented as a separate performance-altered state, or a separate setting of an already existing performance-altered state (e.g., a speed limited performance-altered state).

Similarly, the owner of the vehicle 10 may define one or more geographic boundaries, areas, or geofences within which the vehicle 10 is limited from transporting. For example, if the vehicle 10 is a utility cart, the owner of the vehicle 10 may desire to reduce vehicle traffic at a clubhouse and can define a geofence around the clubhouse that limits the vehicle 10 from being driven into the geofence around the clubhouse (e.g., a geofence of 100 feet surrounding the clubhouse). The owner of the vehicle 10 may similarly define a credential that must be entered by the operator of the vehicle 10 (e.g., a superintendent) in order to enter the geofence. The UI manager 610 and the control manager 612 can implement this performance-altered state by preventing operations of the driveline 50 to transport the vehicle 10 into the geofence (e.g., based on the position obtained by the GPS 306) such as by shutting off the primary mover 52 when at the boundary of the geofence. The UI manager 610 may, responsive to the vehicle 10 being at the boundary to enter a geofence of a restricted area, or responsive to the vehicle 10 being at the boundary to leave a geofence of an approved area, operate the touch screen 62 to prompt the operator of the vehicle 10 to input credentials with sufficient authorization (e.g., credentials set by the owner or administrator of the vehicle 10). In some embodiments, the control manager 612 limits operations of the drivelines 50 that would cause the vehicle 10 to be driven into a restricted geofence or out of an approved geofence until sufficiently authorized credentials are entered, but allow driving operations of the vehicle 10 to transport the vehicle 10 back into the approved geofence or away from the boundary of the restricted geofence (e.g., allowing the vehicle 10 to be driven in reverse away from the boundary of the geofence).

Advantageously, the multi-level access control system 300 as described herein with reference to FIGS. 4-7 facilitates different states and levels of access to the vehicle 10 using credentials that can be entered by the user without requiring the user to carry a separate physical device such as a key. The multi-level access control system 300 stores a previously active state in memory, as well as specific settings of the state (e.g., reduced speed setting) and when being transitioned out of the disabled state automatically re-activates the previously active state and associated settings. The performance-altered state and the disabled state may advantageously be effectively nested due to the multi-level access control system 300 remembering the previous enabled or active state while in the disabled state and returning to that state when unlocked from the disabled state.

It should be understood that while the multi-level access control system 300 as described herein with reference to FIGS. 4-7 is implemented on a vehicle, various features of the multi-level access control system 300 may be implemented for other equipment or devices. For example, the multi-level access control system 300 may be implemented on a computer system such that the computer system defaults back to a previously active state when transitioned out of a disabled or inactive state. The multi-level access control system 300 can also be implemented on appliances, computer devices, or other equipment where it is desired to have different levels of access.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.), the site monitoring and control system 200 (e.g., the remote systems 240, the user portal 230, the user sensors 220, etc.), and the multi-level access control system 300 as shown in the various exemplary embodiments is illustrative only. Additionally, any element disclosed in one embodiment may be incorporated or utilized with any other embodiment disclosed herein.

1. A golf cart comprising:
a user interface; and
processing circuitry configured to:
operate the golf cart according to either (1) a first state where one or more operational capabilities of the golf cart is unrestricted or limited at a first level or (2) a second state where the one or more operational capabilities of the golf cart is limited at a second level, the second level of limitation being more restrictive that the first level;
responsive to a first request provided by a user via the user interface, transitioning the golf cart into a third state where the operation of the golf cart is disabled; and
responsive to a second request provided by the user via the user interface and a verification of a credential of the user, transitioning the golf cart out of the third state and into a previously active state that is either the first state or the second state.

2. The golf cart of claim 1, wherein in the second state, a speed of the golf cart is limited to a threshold, the threshold being less than a speed that the golf cart can achieve in the first state.

3. The golf cart of claim 1, wherein in the second state, the golf cart is limited from being driven into a restricted geographic area or out of an approved geographic area.

4. The golf cart of claim 1, wherein the processing circuitry is configured to operate the golf cart according to either the first state or the second state by causing a primary mover of the golf cart to drive a tractive element of the golf cart based on a control input provided by the user.

5. The golf cart of claim 1, wherein the one or more operational capabilities of the golf cart is limited according to a user defined threshold, wherein the processing circuitry is configured to receive a third request at the user interface or a personal computer device to set or update the user defined threshold, and, responsive to authorization of credentials provided by the user that indicate sufficient authorization, operate the user interface or the personal computer device to prompt the user to set or adjust the user defined threshold.

6. The golf cart of claim 1, wherein the user interface includes a touch screen and the credential of the user includes a typed credential entered at the user interface comprising a password or a personal identification number.

7. The golf cart of claim 1, wherein the user interface includes a biometric sensor and the credential of the user includes at least one of a fingerprint, an eye scan, facial scan, or voice input of the user.

8. The golf cart of claim 1, wherein the processing circuitry is configured to identify different levels of authorization corresponding to different credentials, wherein the processing circuitry is configured to limit transition of the golf cart out of the second state and into the first state until the user provides credentials corresponding to a first authorization level sufficient to transition the golf cart into the first state in which the golf cart is operable in an unrestricted manner, the processing circuitry further configured to restrict transition of the golf cart out of the third state into the first state but allow transition of the golf cart into the second state in response both (i) the previously active state being the second state and (ii) obtaining credentials corresponding to a second authorization level insufficient to transition the golf cart into the first state but sufficient to transition the golf cart into the second state.

9. An access control system for a vehicle, the access control system comprising:
processing circuitry configured to:
operate the vehicle according to either (1) a first state where one or more operational capabilities of the vehicle is unrestricted or limited at a first level or (2) a second state where the one or more operational capabilities of the vehicle is limited at a second level, the second level of limitation being more restrictive that the first level;
responsive to a first request provided by a user, transitioning the vehicle into a third state where the operation of the vehicle is disabled; and
responsive to a second request provided by the user and a verification of a credential of the user, transitioning the vehicle out of the third state and into a previously active state that is either the first state or the second state.

10. The access control system of claim 9, wherein in the second state, a speed of the vehicle is limited to a threshold, the threshold being less than a speed that the vehicle can achieve in the first state.

11. The access control system of claim 9, wherein in the second state, the vehicle is limited from being driven into a restricted geographic area or out of an approved geographic area.

12. The access control system of claim 9, wherein the processing circuitry is configured to operate the vehicle according to either the first state or the second state by causing a primary mover of the vehicle to drive a tractive element of the vehicle based on a control input provided by the user.

13. The access control system of claim 9, wherein the one or more operational capabilities of the vehicle are limited according to a user defined threshold, wherein the processing circuitry is configured to receive a third request to set or update the user defined threshold, and, responsive to authorization of credentials provided by the user that indicate sufficient authorization, operate a user interface or a personal computer device to prompt the user to set or adjust the user defined threshold.

14. The access control system of claim 9, further comprising a user interface, wherein the user interface includes a touch screen and the credential of the user includes a typed credential entered at the user interface comprising a password or a personal identification number.

15. The access control system of claim 9, wherein the user interface includes a biometric sensor and the credential of the user includes at least one of a fingerprint, an eye scan, or a voice input of the user.

16. The access control system of claim 9, wherein the processing circuitry is configured to identify different levels of authorization corresponding to different credentials, wherein the processing circuitry is configured to limit transition of the vehicle out of the second state and into the first state until the user provides credentials corresponding to a first authorization level sufficient to transition the vehicle into the first state in which the vehicle is operable in the unrestricted manner, the processing circuitry further configured to restrict transition of the vehicle out of the third state and into the first state but allow transition of the vehicle into the second state in response both (i) the previously active state being the second state and (ii) obtaining credentials corresponding to a second authorization level insufficient to transition the vehicle into the first state but sufficient to transition the vehicle into the second state.

17. A method of providing access to a vehicle, the method comprising:
operating the vehicle according to either (1) a first state where one or more operational capabilities of the vehicle is unrestricted or limited at a first level or (2) a second state where the one or more operational capabilities of the vehicle is limited at a second level, the second level of limitation being more restrictive that the first level;
responsive to a first request provided by a user via a user interface, transitioning the vehicle into a third state where the operation of the vehicle is disabled; and
responsive to a second request provided by the user via the user interface and a verification of credentials of the user, transitioning the vehicle out of the third state and into a previously active state that is either the first state or the second state.

18. The method of claim 17, wherein in the second state, a speed of the vehicle is limited to a threshold, the threshold being less than a speed that the vehicle can achieve in the first state.

19. The method of claim 16, wherein in the second state, the vehicle is limited from being driven into a restricted geographic area or out of an approved geographic area.

20. The method of claim 16, wherein operating the vehicle according to either the first state or the second state comprises causing a primary mover of the vehicle to drive a tractive element of the vehicle based on a control input provided by the user.
